(19) United States
(12) Patent Application Publication
(10) Pub. No.: US 2006/0273919 A1
(43) Pub. Date: Dec. 7, 2006

(54) Warning indicator with liquid crystal lens

(76) Inventors: Susumu Sato, Akita (JP); Rumiko Yamaguchi, Akita (JP); Setsuko Itoh, Akita (JP); Miyuki Natita, Akita (JP); Yoshiaki Akanuma, Akita (JP); Takeshi Oshino, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/142,375

(22) Filed: Jun. 2, 2005

(51) Int. Cl. G09F 9/33

(52) U.S. Cl. 340/815.45

(57) ABSTRACT

There is provided a warning indicator with a liquid crystal lens, suitable for warning indication in various types of instruments. It uses a liquid crystal lens to display an image in an appropriate scale on an indication panel. The warning indicator with a liquid crystal lens includes a light source such as LED, and a two-layer liquid crystal lens (4) disposed over a character or symbol indicated by the light source and which is formed from a twisted nematic liquid crystal cell (1) and a lens-shaped homogeneous liquid crystal cell (3). The focal distance of the liquid crystal lens (4) is electrically varied to allow a virtual image of the character or symbol indicated in a meter to appear larger or smaller than its real size.

### BACKGROUND OF THE INVENTION

1. Field of the Invention

The present invention relates to a warning indicator with a liquid crystal lens for use as a warning sign on an instrument panel in an automobile, an aircraft and a train, and as an emergency exit sign in a theater or the like to freely display an image in a variable scale through the liquid crystal lens formed from liquid crystal cells.

2. Description of the Related Art

Generally, the visibility of the warning sign used on the conventional instrument panel or switch is assured by displaying the warning sign in a larger scale, turning on or blinking the warning sign or by reflecting the light from the warning sign.

For improvement of the above visibility, there have heretofore been proposed indicators in which a liquid crystal lens is used to variably adjust the lens focal distance for a brighter image as disclosed in the Japanese Patent Application Laid Open Nos. 130380 of 1994, 235932 of 1994, 2004-144874 and 2004-219483. Also, the Japanese Patent Application Laid Open No.230284 of 1997 discloses an indicator in which a liquid crystal lens is used as a condenser lens whose refractive index can freely be adjusted. Moreover, an indicator using the switching function and focus changing function of an liquid crystal lens is disclosed in the Japanese Patent Application Laid Open No. 2004-252429.

However, the conventional liquid crystal lens is disadvantageous in that since the response time and recovery time of the liquid crystal molecule array are longer in proportion nearly with the square of the thickness of the liquid crystal layer when a liquid crystal lens having a larger size is applied with a voltage.

Also, in the warning sign used on the conventional instrument panel or switch, since the sign itself (character or symbol) is fixed in color and size, its initial visibility is lower after the warning sign once turned on is continuously kept on or repeatedly turned on and off.

Further, a larger size of the warning sign for better visibility will lead to the necessity of increasing the size of the instrument itself on which the warning sign is installed. That is, it is difficult to design a smaller and thinner warning indicator as a warning sign.

### OBJECT AND SUMMARY OF THE INVENTION

It is therefore an object of the present invention to overcome the above-mentioned drawbacks of the related art by providing a warning indicator with a liquid crystal lens formed from two liquid crystal layers having a lens function and switching function, respectively, and which is used to electrically control the size of a warning sign itself for better visibility of the latter without having to design a larger instrument panel for installation of the warning indicator.

According to one aspect of the present invention, there is provided a warning indicator with a liquid crystal lens, including a light source such as LED, and a two-layer liquid crystal lens disposed over a character or symbol indicated by the light source and which is formed from a liquid crystal cell whose liquid crystal molecules can be aligned in a direction which is electrically changed and a lens-shaped homogeneous liquid crystal cell whose liquid crystal molecules are aligned in parallel with substrates of the cell and in one direction between the substrates, the focal distance of the liquid crystal lens being electrically varied to allow the image of the character or symbol indicated in a meter to appear as a virtual image having a size larger or smaller than the real size of the original image.

Also, according to another aspect of the present invention, there is provided a warning indicator with a liquid crystal lens, including a light source such as LED, and a combination of a polarizer with a two-layer liquid crystal lens formed from a liquid crystal cell whose liquid crystal molecules are aligned in a direction which is electrically changed and a lens-shaped homogeneous liquid crystal cell whose liquid crystal molecules are aligned in parallel with substrates of the cell and in one direction between the substrates, or with an optical anisotropic optical lens or Fresnel lens, disposed over a character or symbol indicated by the light source, the magnification of the liquid crystal lens being electrically varied to allow a virtual image of the character or symbol indicated in a meter to appear as if it moved from its real size to a larger or smaller one.

Also, according to still another aspect of the present invention, there is provided a warning indicator with a liquid crystal lens, including a light source such as LED, and a two-layer liquid crystal lens disposed over a character or symbol indicated by the light source and which is formed from a liquid crystal cell whose liquid crystal molecules are aligned in a direction which is electrically changed and a lens-shaped homogenous liquid crystal cell whose liquid crystal molecules are aligned in parallel with substrates of the cell and in one direction between the substrates, the character or symbol being indicated as a real image on a reflector through the two-layer liquid crystal lens or on any other display panel via the reflector, and the focal distance of the liquid crystal lens being electrically varied to allow a real image of the indicated character or symbol to appear larger or smaller.

Also, according to yet another object of the present invention, there is provided a warning indicator with a liquid crystal lens, including a combination of a polarizer with a two-layer liquid crystal lens formed from a liquid crystal cell whose liquid crystal molecules are aligned in direction which is electrically changed and a lens-shaped homogeneous liquid crystal cell, or with an optical anisotropic liquid crystal lens or Fresnel lens, and a light source such as LED, a desired character or symbol being indicated as a real image on a reflector through the two-layer liquid crystal lens or on any other display panel via the reflector, and the polarizer being electrically controlled to change the lens magnification in order to allow a real image of the character or symbol indicated in a meter on the reflector to appear as if it moved from its real size to a larger or smaller one.

Note that the liquid crystal whose liquid crystal molecules can electrically be changed refers herein to a liquid crystal whose optical phase shift can electrically be controlled, such as twisted nematic liquid crystal, homogeneous liquid crystal and host-guest liquid crystal.

In the warning indicator with a liquid crystal lens according to the present invention, the liquid crystal lens is composed of the liquid crystal cell (twisted nematic liquid crystal cell) whose polarized direction can be changed and lens-shaped homogeneous liquid crystal cell as above. By applying a voltage to the liquid crystal lens, the light is allowed to travel straight through the untwisted twisted nematic (TN) liquid crystal cell (will be referred to as “TN liquid crystal cell” hereunder) and the linear polarized light incident upon the lens-shaped homogeneous liquid crystal cell as the next stage of the lens becomes parallel to the long axis of the liquid crystal molecules. The light traveling through the lens-shaped homogeneous liquid crystal cell while being refracted through a solvent (homogeneous liquid crystal) having a refractive index applied to an extraordinary light is converged or diverged under the action of the applied voltage.

It is well known that the conventional liquid crystal lens will be slower in speed of response as its size is larger. In the two-layer liquid crystal lens according to the present invention, no voltage is applied to the lens-shaped homogeneous liquid crystal lens while a voltage is applied to the TN liquid crystal cell which has a light switching function, to thereby select a polarization, namely, either an ordinary or extraordinary light. Thus, a character or symbol can be indicated sharper.

In the warning indicator with a liquid crystal lens according to the present invention, the liquid crystal lens to project a character or symbol indicated by the light source such as LED is a two-layer liquid crystal lens composed of a TN liquid crystal cell having the switching function and a homogeneous liquid crystal cell having the lens function, and the focal distance of the liquid crystal lens is electrically controlled, the lens magnification is controlled by selecting the polarization with a polarizer being combined with the TN liquid crystal cell, thereby allowing the character or symbol indicated in the meter to appear larger or smaller than its real size.

Also, a desired character or symbol can be indicated as a real image on the reflector through the liquid crystal lens, and the TN liquid crystal cell combined with a polarizer is electrically controlled to change the lens magnification, thereby allowing the real image to appear larger or smaller.

That is, since the two-layer liquid crystal lens according to the present invention can allow an image to be indicated in an enlarged or reduced scale and can have the focal distance thereof changed, it provides a high-visibility warning indicator.

Further, since the two-layer liquid crystal lens can easily be installed on an existing indicator, it can easily improve the visibility of the indicator. Therefore, the focal distance of the liquid crystal lens can be changed without using a moving part required when only the conventional optical lens is used. Thus, the liquid crystal lens can easily be installed on an indicator such as an instrument panel. Since the liquid crystal lens can easily be attached to an existing indicator, it can assure a high visibility of a emergency warning sign installed in a theater or hall and will not increase the size of the warning sign so much.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 shows a behavior of light passing through a TN (twisted nematic) liquid crystal cell and a polarizing filter provided at the light-incident end of the TN liquid crystal cell included in a two-layer liquid crystal lens as a substantial part of the liquid crystal lens according to the present invention for a warning sign and indicator, in which FIG. 1(a) explains the light behavior when no voltage is applied to the TN liquid crystal cell and FIG. 1(b) explains that when a voltage is applied to the TN liquid crystal cell;

FIG. 2 shows a behavior of light passing through a two-layer liquid crystal lens including a lens-shaped homogeneous liquid crystal cell in addition to the polarizing filter and TN liquid crystal lens in the two-layer liquid crystal lens shown in FIG. 1, in which FIG. 2(a) explains a light behavior when no voltage is applied to the IN liquid crystal cell, FIG. 2(b) explains a light behavior for image magnification when a voltage is applied to the TN liquid crystal cell and FIG. 2(c) explains a light behavior for image reduction when a voltage is applied to the TN liquid crystal cell;

FIG. 3 is a sectional view of the two-layer liquid crystal lens for projecting a magnified image;

FIG. 4 shows an image display through the two-layer liquid crystal lens for projecting the magnified image, in which FIG. 4(a) explains the image display when no voltage is applied to the TN liquid crystal cell and FIG. 4(b) explains that when a voltage is applied to the TN liquid crystal cell;

FIG. 5 shows a reflected image display through the two-layer liquid crystal lens for projecting the magnified image with the use of a reflector, in which FIG. 5(a) explains the image display when no voltage is applied to the TN liquid crystal cell and FIG. 5(b) explains that when a voltage is applied to the TN liquid crystal cell;

FIG. 6 is a sectional view of the two-layer liquid crystal lens for projecting a reduced image;

FIG. 7 shows an image display through the two-layer liquid crystal lens for projecting the reduced image, in which FIG. 4(a) explains the image display when no voltage is applied to the TN liquid crystal cell and FIG. 4(b) explains that when a voltage is applied to the TN liquid crystal cell;

FIG. 8 shows a reflected image display through the two-layer liquid crystal lens for projecting the reduced image with the use of a reflector, in which FIG. 5(a) explains the image display when no voltage is applied to the TN liquid crystal cell and FIG. 5(b) explains that when a voltage is applied to the TN liquid crystal cell; and

FIG. 9 shows an image display by the liquid crystal lens according to the present invention for a warning sign and indicator, which is assembled to an automotive warning indicator, in which FIG. 9(a) (photo) shows an image not magnified nor reduced and FIG. 9(b) shows an image magnified.

### DETAILED DESCRIPTION OF THE PREFERRED EMBODIMENTS

The present invention will be described in detail below concerning an embodiment of the warning indicator with a liquid crystal lens according thereto with reference to the accompanying drawings.

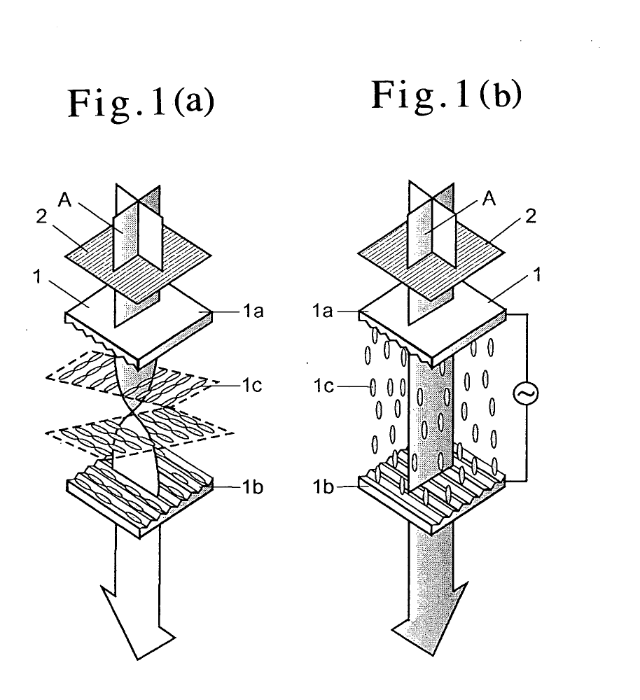

The action of the liquid crystal lens will be described in detail. When a TN liquid crystal cell 1 is not applied with any voltage, light A will be twisted through 90 deg. along the twist of liquid crystal molecules in the TN liquid crystal cell 1 as shown in FIG. 1(a). However, when the TN liquid crystal cell 1 is applied with a voltage, the TN liquid crystal cell 1 will be untwisted and so the light A will travel straight without dependence of its behavior upon the twist of the liquid crystal molecules as shown in FIG. 1(b). It should be noted that in FIG. 1, reference numerals 1a and 1b indicate alignment films, respectively, disposed opposite to each other with a predetermined gap between them, and 1c indicates a TN liquid crystal interposed between the alignment films 1a and 1b.

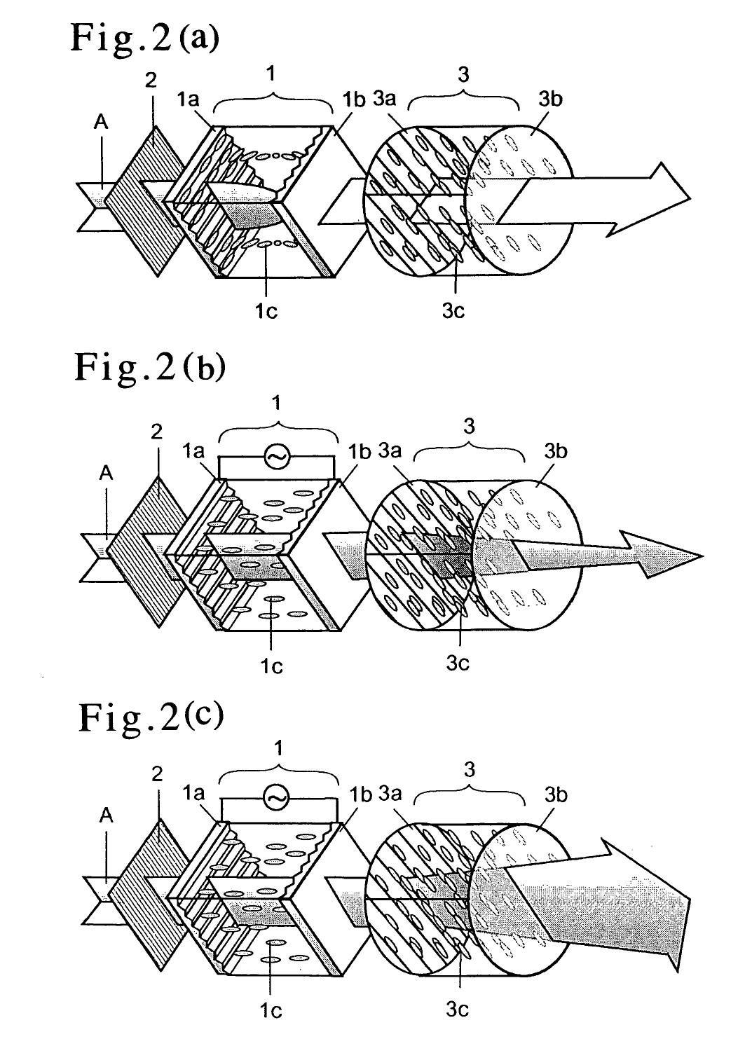

In case a polarizing filter (polarizer) 2 is disposed at the light-incident side of the liquid crystal lens, the light A incident upon the polarizing filter 2 will be linearly polarized as shown in FIG. 2. When the TN liquid crystal cell 1 is not applied with any voltage as shown in FIG. 1(a), the light A will pass by the TN liquid crystal cell 1 and then be polarized in another direction. Alternatively, when the TN liquid crystal cell 1 is applied with a voltage as shown in FIG. 1(b), the polarized light A passing by the TN liquid crystal cell 1 will not be polarized in any other direction. Thereafter, the light A will be incident upon a lens-shaped homogeneous liquid crystal cell 3 at a next stage as shown in FIG. 2(a). That is, the linear polarized light A having passed by the TN liquid crystal cell 1 having the polarizing filter 2 disposed at the light-incident side thereof will travel in a direction perpendicular to the long axis of a homogeneous liquid crystal 3c in each of alignment films 3a and 3b of the lens-shaped homogeneous liquid crystal cell 3. More specifically, when the light A is an ordinary light, it will travel straight in little-diverged or -converged state as shown in FIG. 2(b). When the light A travels in parallel to the long axis of the homogeneous liquid crystal 3c, namely, when it is an extraordinary light, it will travel convergently or divergently as shown in FIG. 2(c). It should be noted that the refractive index of a flat convex or flat concave transparent lens included in the lens-shaped homogeneous liquid crystal cell 3 is generally equal to that of the homogeneous liquid crystal for the ordinary light.

The above will be described more particularly. When no voltage is applied to the TN liquid crystal cell 1, the light A will pass by the polarizing filter 2 in which it will be linearly polarized and then incident upon the TN liquid crystal cell 1. Since the TN liquid crystal 1c between the alignment films 1a and 1b perpendicular to each other inside the TN liquid crystal cell 1 is parallel to the direction of alignment of the alignment films in the vicinity of the boundary between the alignment films 1a and 1b, it is disposed being continuously twisted through 90 deg. between the alignment films 1a and 1b. The linearly polarized light A incident upon the TN liquid crystal cell 1 will be polarized in a 90 deg.-turned direction along the twist of the TN liquid crystal 1c while passing by the liquid crystal cell 1. Thereafter, the linearly polarized light A polarized in the 90 deg.-turned direction will be incident upon the lens-shaped homogeneous liquid crystal cell 3 perpendicularly to the long axis of the liquid crystal molecules of the homogeneous liquid crystal 3c at the next stage. The linearly polarized light A will travel straight, not being refracted, through the lens-shaped homogeneous liquid crystal cell 3 as shown in FIG. 2(a). As a result, the light A is neither converged nor diverged and an image will appear as a not-magnified or -reduced virtual image.

On the other hand, when an voltage is applied to the TN liquid crystal cell 1, the light A will pass by the polarizing filter 2 in which it will be linearly polarized and then incident upon the TN liquid crystal cell 1 which has a switching function. At this time, the TN liquid crystal 1c between the two alignment films 1a and 1b perpendicular to each other inside the TN liquid crystal cell 1 is untwisted and will travel the long axis thereof turned in the direction of the electric field and travel perpendicularly to the alignment films 1a and 1b as shown in FIG. 1(b). The linearly polarized light A incident upon the TN liquid crystal cell 1 will travel straight through the TN liquid crystal cell 1. Thereafter, the linearly polarized light A will incident upon the lens-shaped homogenous liquid crystal cell 3 having disposed therein the homogeneous liquid crystal 3c whose long axis is parallel to the light A. The linearly polarized light A will travel straight while being refracted in the lens-shaped homogeneous liquid crystal cell 3. As a result, the light A will travel being converged (when a voltage is applied to the TN liquid crystal cell 1) as shown in FIG. 2(b), or will travel being diverged (when no voltage is applied to the TN liquid crystal cell 1) as shown in FIG. 2(c). An image will appear as an erecting virtual image, magnified or reduced.

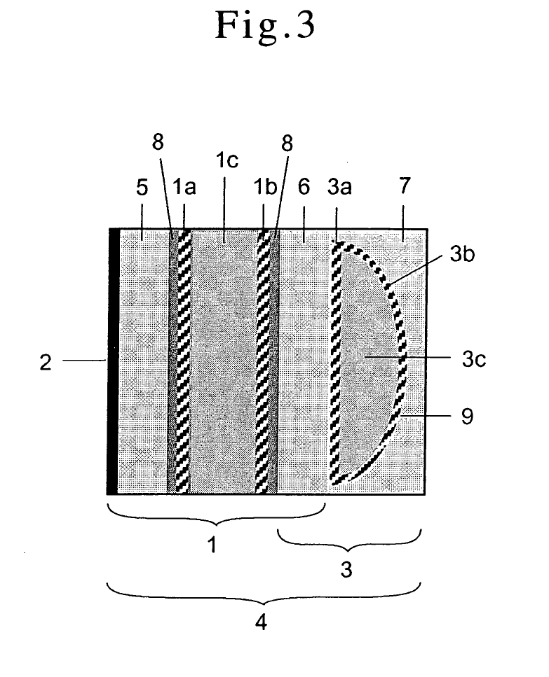

Referring now to FIGS. 3 to 8, there is illustrated the warning indicator with a liquid crystal, including, in combination, a two-layer liquid crystal lens formed from a twisted nematic (TN) liquid crystal cell and lens-shaped homogenous liquid crystal cell, and a polarizing filter. FIG. 3 shows, in an enlarged scale, the two-layer liquid crystal lens that provides an enlarged image. The two-layer liquid crystal lens is generally indicated with a reference numeral 4. As shown, the two-layer liquid crystal lens 4 includes mainly a first flat transparent substrate 5, a second flat transparent substrate 6 disposed opposite to the first flat transparent substrate 5, a third concave transparent substrate 7 disposed opposite to the second flat transparent substrate 6, TN liquid crystal 1c sealed in a space defined between the transparent substrates 5 and 6, a convex lens 9 formed from homogenous liquid crystal 3c sealed in a space defined between the transparent substrates 6 and 7, and a polarizing filter 2. It should be noted here that the refractive index (about 1.5) of the third concave transparent substrate 7 is generally equal to that (about 1.5) of the homogeneous liquid crystal 3c for the ordinary light.

Also, between the first and second flat transparent substrates 5 and 6 included in the switching TN liquid crystal cell 1, there are formed a transparent conductive layer 8 and the alignment films 1a and 1b aligned in directions perpendicular to each other in this order. The polarizing filter 2 is disposed outside the first flat transparent substrate 5. Further, outside the second flat transparent substrate 6, there are disposed the third concave transparent substrate 7 and lens-shaped homogeneous liquid crystal cell 3. The alignment films 3a and 3b are disposed inside the lens-shaped homogeneous liquid crystal cell 3.

According to this embodiment, the first and second flat transparent substrates 5 and 6 are for example 0.1 to 2.0 mm thick. This thickness may appropriately be selected according to their mechanical strength and element dimensions, and should preferably be 0.7 to 1.1 mm. Their dimensions, both length and width, are 0.5 to 4.0 cm, preferably 2.0 to 3.0 cm. Also, the space defined by the first and second flat transparent substrates 5 and 6 and having the TN liquid crystal 1c provided therein is 3 to 50 μm thick, preferably 10 to 15 μm. The third concave transparent substrate 7 is 1.0 to 3.0 mm thick, preferably 1.5 to 2.5 mm which however depends upon the magnification of the liquid crystal lens. The dimensions of the third concave transparent substrate 7, both length and width, are 0.5 to 4.0 cm, preferably 2.0 to 3.0 cm. The second flat transparent substrate 6 and third concave transparent substrate 7 define together a convex lens-shaped space in which the homogeneous liquid crystal 3c is disposed and whose diameter is 1.0 to 3.5 cm, preferably 1.5 to 2.5 cm. The radius of curvature of the space is 1.0 to 40.0 mm, preferably 5.0 to 30.0 mm.

The transparent substrates are formed from a material such as high-transmittance, heat-resistant glass, plastic or the like.

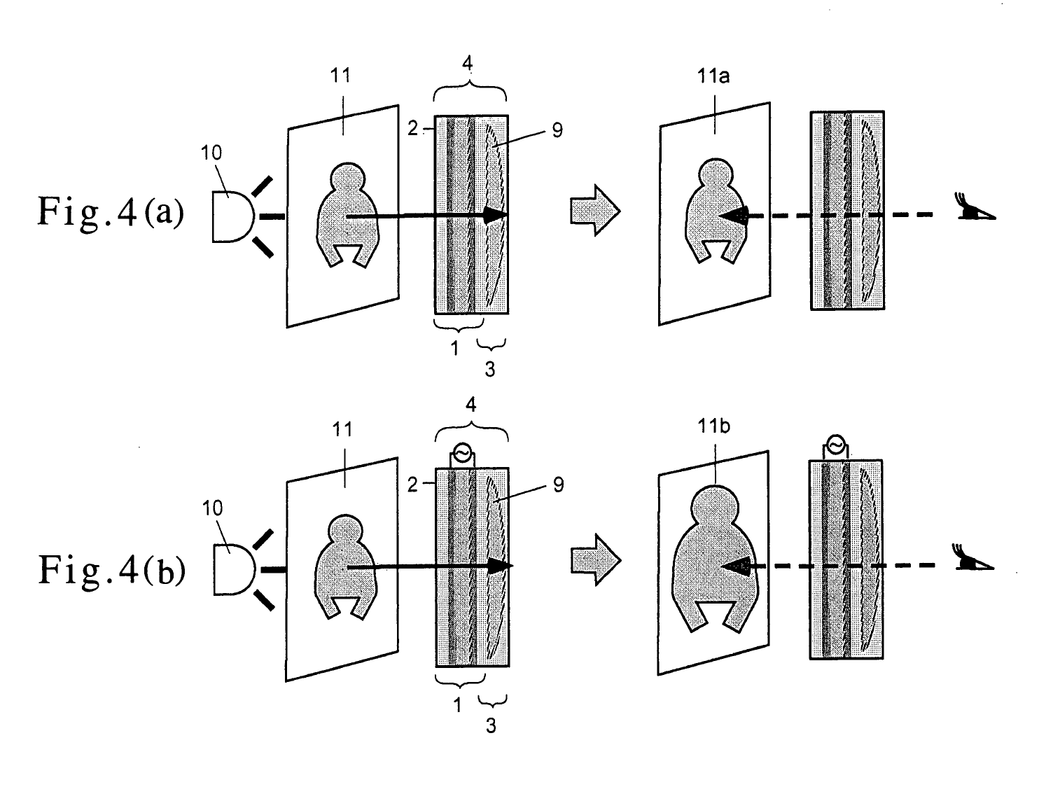

Next, an image display mechanism in which the two-layer liquid crystal lens 4 projects a magnified image will be described below with reference to FIGS. 4(a) and 4(b). When no voltage is applied to the TN liquid crystal cell 1 having the function of switching the two-layer liquid crystal lens 5, an image 11 projected from a light source 10 appears as a not-magnified or -reduced erecting virtual image 11a as shown in FIG. 4(a). When a voltage is applied to the TN liquid crystal cell 1, the image 11 will appear as an erecting virtual image 11b magnified under the effect of the two-layer liquid crystal lens 4 as a convex lens as shown in FIG. 4(b).

By repeating the alternate application of a voltage and no voltage to the switching TN liquid crystal cell 1, the erecting virtual image will repeat alternate appearance as not-magnified or -reduced and magnified so that the indicated virtual image of a character or symbol can appear as changing from its real size to a larger one.

Also, by displaying a desired character or symbol as a virtual image on a reflector through the liquid crystal lens 4 or reflecting them by the reflector for display as virtual images on any other display panel, it is possible to display the image of the character or symbol in an enlarged size.

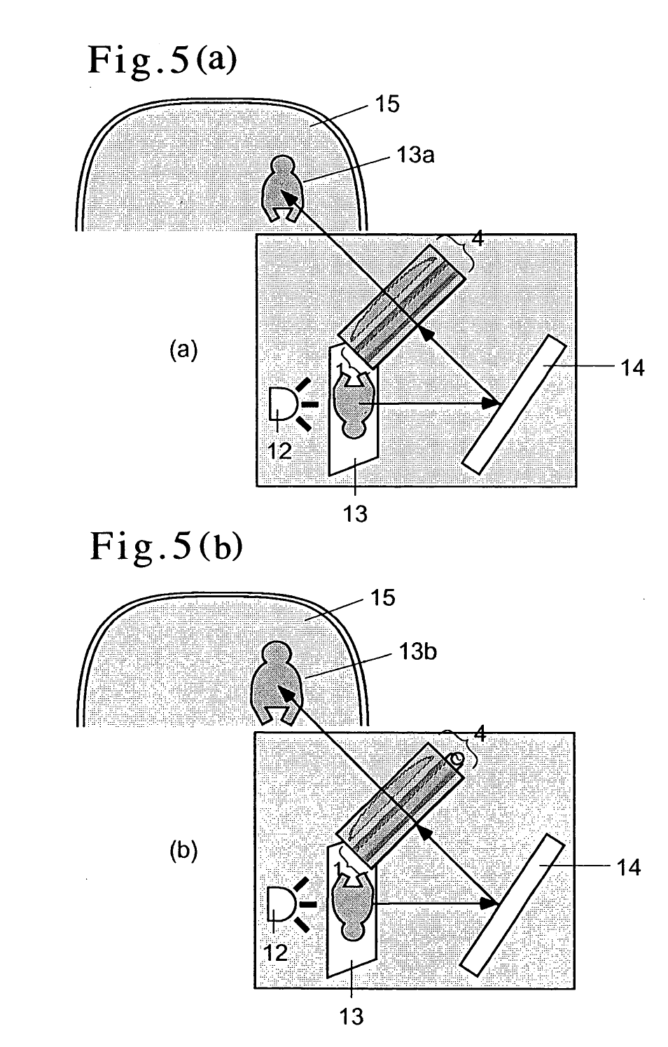

Now, the reflection-type image display mechanism to project a magnified image by a combination of the two-layer liquid crystal lens 4 and a reflector will be described with reference to FIGS. 5(a) and 5(b). As shown, an image 13 projected from a light source 12 is reflected by a reflector 14. When the switching TN liquid crystal cell 1 included in the two-layer liquid crystal lens 4 is applied with no voltage, the image 13 will be projected onto a windshield 15 of an automobile as an inverted real image 13a not magnified or reduced as shown in FIG. 5(a). On the other hand, when the TN liquid crystal cell 1 is applied with a voltage, the image 13 will be projected onto the windshield 15 as an inverted real image 13b magnified under the effect of the two-layer liquid crystal lens 4 as a convex lens as shown in FIG. 5(b).

By quickly repeating the alternate application of a voltage and no voltage to the switching TN liquid crystal cell 1, the inverted real image will repeat alternate appearance as not-magnified or -reduced and magnified so that indicated real image of a character or symbol can appear as changing from its real size to an larger one.

Also, as a variant of the aforementioned embodiment of the warning indicator according to the present invention, an optically anisotropic convex optical lens and Fresnel lens (not shown) may be used in place of the lens-shaped liquid crystal cell 3.

More specifically, when a voltage is applied to the switching TN liquid crystal cell 1, the light will travel straight while being converged through the optical anisotropic convex optical lens and Fresnel lens and the image will appear as a magnified erecting virtual image.

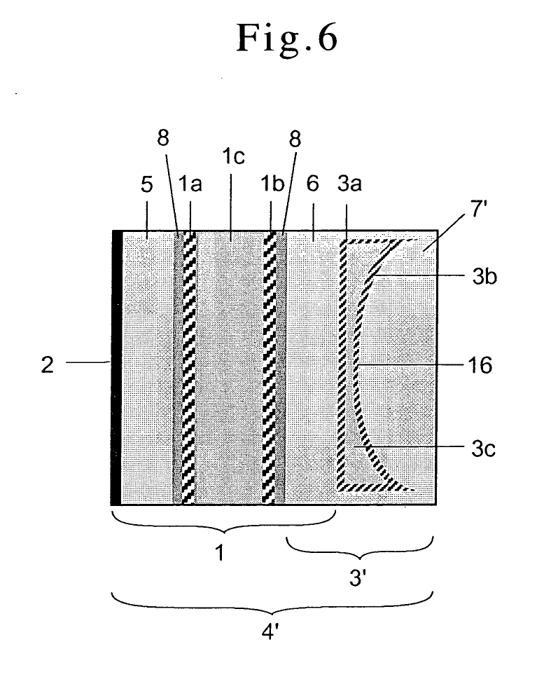

FIG. 6 shows a two-layer liquid crystal lens 4′ which projects a reduced image includes a first flat transparent substrate 5, second flat transparent substrate 6 disposed opposite to the first flat transparent substrate 5, third convex transparent substrate 7′ disposed opposite to the second flat transparent substrate 6, IN liquid crystal 1c sealed in a space defined between the transparent substrates 5 and 6, concave lens 12 formed from a homogeneous liquid crystal 3c sealed in a space defined between the transparent substrates 6 and 7, and a polarizing filter 2 disposed at the free end of the first flat transparent substrate 5. Further, the TN liquid crystal 1c and homogeneous liquid crystal 3c are thus disposed between the transparent substrates to form the switching TN liquid crystal cell 1 and lens-shaped homogeneous liquid crystal cell 3′, respectively.

Between the first and second flat transparent substrates 5 and 6 included in the switching TN liquid crystal cell 1, there are disposed the transparent conductive layer 8 and the alignment films 1a and 1b in this order as having previously been described. The polarizing filter 2 is disposed outside the first flat transparent substrate 5. Further, outside the second flat transparent substrate 6, there are formed a third convex transparent substrate 7′ and lens-shaped homogeneous liquid crystal cell 3′. The alignment films 1a and 1b are disposed inside the TN liquid crystal cell 1.

The two-layer liquid crystal lens 4′ to project a reduced image is formed to have such dimensions that, for example, the first and second flat transparent substrates 5 and 6 are 0.1 to 2.0 mm thick. This thickness may appropriately be selected according to their mechanical strength and element dimensions, and should preferably be 0.7 to 1.1 mm. Their dimensions, both length and width, are 0.5 to 4.0 cm, preferably 2.0 to 3.0 cm. Also, the space defined by the first and second flat transparent substrates 5 and 6 and having the TN liquid crystal 1c provided therein is 3 to 50 μm thick, preferably 10 to 15 μm. The third convex transparent substrate 7′ is 1.0 to 3.0 mm thick, preferably 1.5 to 2.5 mm. The dimensions of the third convex transparent substrate 7′, both length and width, are 0.5 to 4.0 cm, preferably 2.0 to 3.0 cm. The second flat transparent substrate 6 and third convex transparent substrate 7′ define together a convex lens-shaped space in which the homogeneous liquid crystal 3c is provided and whose diameter is 1.0 to 3.5 cm, preferably 1.5 to 2.5 cm. The radius of curvature of the space is −1.0 to −40.0 mm, preferably −5.0 to −30.0 mm.

The transparent substrates are formed from a material such as high-transmittance, heat-resistant glass, plastic or the like.

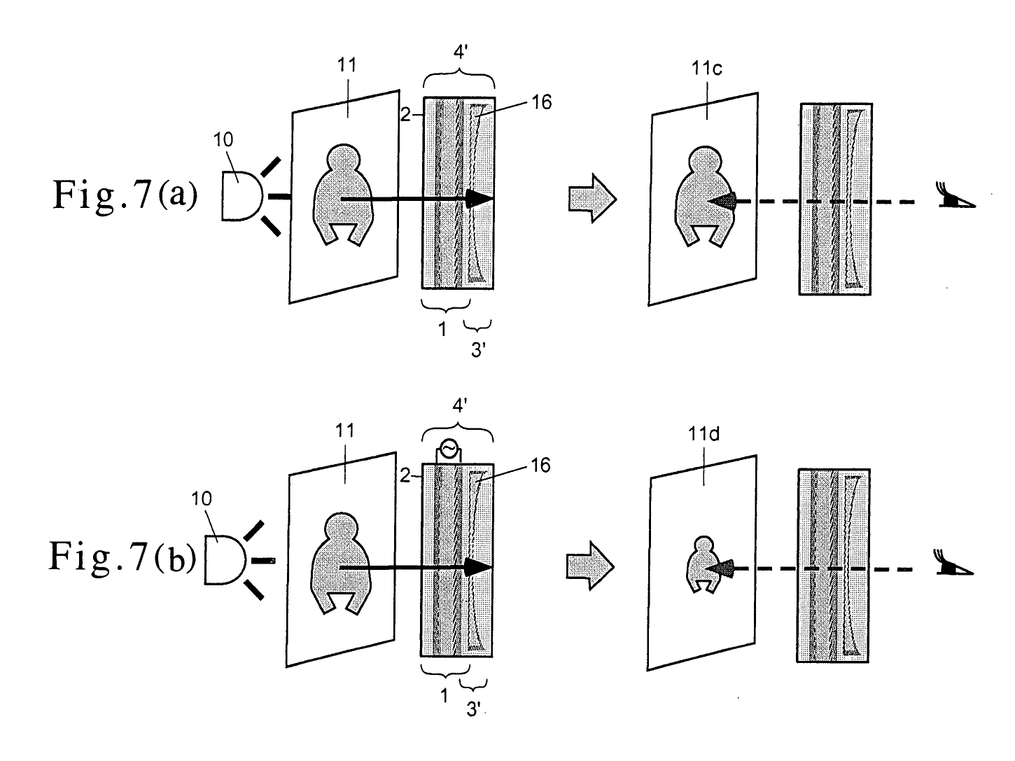

Next, an image display mechanism in which the two-layer liquid crystal lens 4′ projects a magnified image will be described below with reference to FIGS. 7(a) and 4(b). When a voltage is applied to the TN liquid crystal cell 1 having the function of switching the two-layer liquid crystal lens 4′, an image 11 projected from the light source 10 appears as an erecting virtual image 11d reduced under the effect of refraction by the concave lens 12 having the homogeneous liquid crystal 3c as shown in FIG. 7(b).

By repeating the alternate application of a voltage and no voltage to the switching TN liquid crystal cell 1, the erecting virtual image will repeat alternate appearance as not-magnified or -reduced and magnified so that an indicated virtual image of a character or symbol can appear as changing from its real size to a smaller one.

Also, by displaying a desired character or symbol as a virtual image on a reflector through the liquid crystal lens 4 or reflecting them by the reflector for display as a virtual image on any other display panel, it is possible to display the image of the character or symbol in a reduced size.

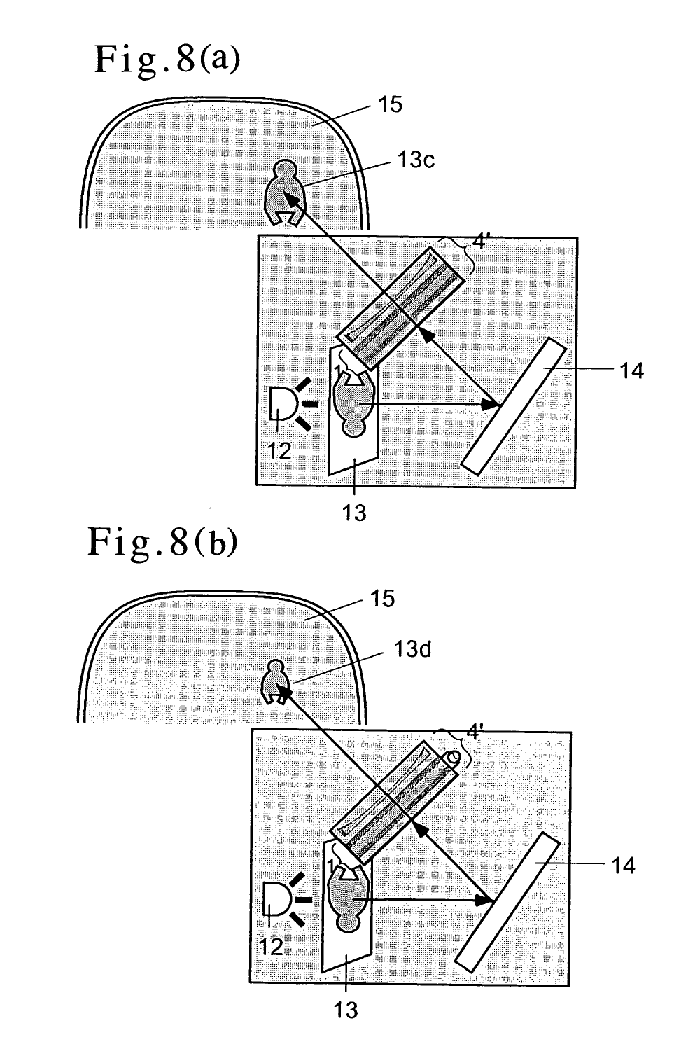

Now, the reflection-type image display mechanism to project a reduced image by a combination of the two-layer liquid crystal lens 4′ and a reflector will be described with reference to FIGS. 8(a) and 8(b). As shown, an image 13 projected from a light source 12 is reflected by a reflector 14. When the switching TN liquid crystal cell 1 included in the two-layer liquid crystal lens 4′ is applied with no voltage, the image 13 will be projected onto the windshield 15 of an automobile as an inverted virtual image 13c not magnified or reduced as shown in FIG. 8(a). On the other hand, when the TN liquid crystal cell 1 is applied with a voltage, the image 13 will be projected onto the windshield 15 as an inverted virtual image 13d reduced under the effect of the two-layer liquid crystal lens 4′ as a concave lens as shown in FIG. 8(b).

By quickly repeating the alternate application of a voltage and no voltage to the switching TN liquid crystal cell 1, the inverted real image will repeat alternate appearance as not-magnified or -reduced and reduced so that an indicated real image of a character or symbol can appear as changing from its real size to a smaller one.

Also, as another variant of the aforementioned embodiment of the image indicator according to the present invention, an optically anisotropic concave optical lens and Fresnel lens (not shown) may be used in place of the lens-shaped liquid crystal cell.

More specifically, when a voltage is applied to the switching TN liquid crystal cell 1, the light will travel straight while being diverged through the optical anisotropic concave optical lens and Fresnel lens and the image will appear as a reduced inverted virtual image.

### EXAMPLES

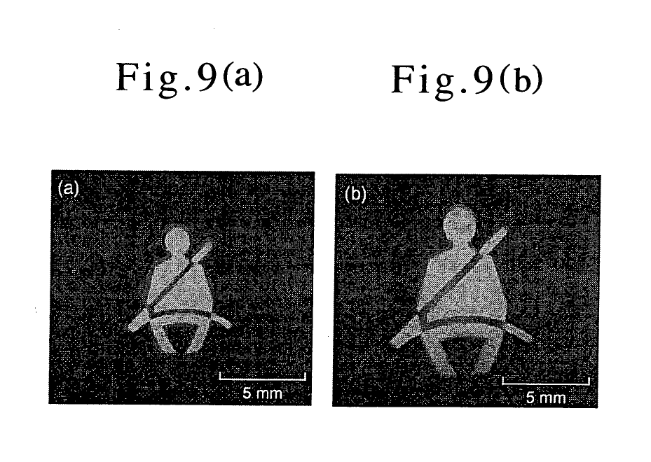

The present will be described in detail concerning the examples thereof. The liquid crystal was charged following the common procedure. The warning indicator used was a well-known automotive warning indicator, and the two-layer liquid crystal lens 1 was disposed in front of the automotive warning sign. The automotive warning indicator was normally operated and the switching TN liquid crystal cell was applied wit a voltage of 6 V (1 kHz). The image captured by the magnified image display mechanism as shown in FIGS. 4(a) and 4(b) is shown in FIG. 9 (photo 1). The image not magnified nor reduced was 6.5 mm long and 7.2 mm wide. The image magnified by the two-layer liquid crystal lens was 8.3 mm long and 9.3 mm wide. That is, the magnification of the two-layer liquid crystal lens is 1.25. Also, on the assumption that the brightness of the image not magnified or reduced, namely, when no voltage was applied, is 100%, the bright of the image magnified, namely, when the voltage was applied, was 95%. That is, the enlargement of the image with the voltage application causes a 5% reduction of the brightness. However, no change was found in the visibility of the image. Further, the response speed at the time of switching from the image not magnified or reduced with application of no voltage to the image magnified with application of the voltage was less than 1 sec.

The results of the experiments show that the two-layer liquid crystal lens according to the present invention is effective as an enlarged-in-scale display and has a quick on/off switching function without deterioration of the image visibility.

Since the two-layer liquid crystal lens according to the present invention can easily be installed on an existing indicator, it can readily improve the image visibility of the indicator.

Further, since the two-layer liquid crystal lens according to the present invention can have the focal distance thereof varied without any moving part which is required for any conventional optical lens, the lens itself has not to be thick and thus can easily be installed on an indicator such as an instrument. That is, the two-layer liquid crystal lens according to the present invention can thus easily be installed to an existing indicator, and hence it can be used on a warning sign as well as on an indicator whose image visibility should be improved.

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

What is claimed is:

1. A warning indicator with a liquid crystal lens, comprising:
a light source such as LED; and
a two-layer liquid crystal lens disposed over a character or symbol indicated by the light source and which is formed from a twisted nematic liquid crystal cell and a lens-shaped homogeneous liquid crystal cell,
the focal distance of the liquid crystal lens being electrically varied to allow a virtual image of the character or symbol indicated in a meter to appear larger or smaller than its real size.

2. A warning indicator with a liquid crystal lens, comprising:
a light source such as LED; and
a two-layer liquid crystal lens disposed over a character or symbol indicated by the light source and which is formed from a twisted nematic liquid crystal cell and a lens-shaped homogeneous liquid crystal cell,
the focal distance of the liquid crystal lens being electrically varied to allow a virtual image of the character or symbol indicated in a meter to appear as if it moved from its real size to a larger or smaller one.

3. A warning indicator with a liquid crystal lens, comprising:
a light source such as LED; and
a two-layer liquid crystal lens disposed over a character or symbol indicated by the light source and which is formed from a twisted nematic liquid crystal cell and a lens-shaped homogeneous liquid crystal cell,
the character or symbol being indicated as a real image on a reflector through the liquid crystal lens or on any other reflector via the reflector; and
the focal distance of the liquid crystal lens being electrically varied to allow a real image of the indicated character or symbol to appear larger or smaller than its real size.

4. A warning indicator with a liquid crystal lens, comprising:
a light source such as LED; and
a two-layer liquid crystal lens disposed over a character or symbol indicated by the light source and which is formed from a twisted nematic liquid crystal cell and a lens-shaped homogeneous liquid crystal cell,
the character or symbol being indicated as a real image on a reflector through the liquid crystal lens or on any other reflector via the reflector; and
the focal distance of the liquid crystal lens being electrically varied to allow a real image of the indicated character or symbol to appear as if it moved from its real size to a larger or smaller one.
